(19) United States
(12) Patent Application Publication
(10) Pub. No.: US 2008/0139781 A1
(43) Pub. Date: Jun. 12, 2008

(54) Use of Amphoteric Polymers for the Treatment of Hard Surfaces to Improve the Wettability Thereof

(75) Inventors: Heike Becker, Mannheim (DE); Volker Braig, Weinheim-Lutzelsachsen (DE); Lidcay Herrera Taboada, Oostende (BE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/910,826

(22) PCT Filed: Apr. 20, 2006
(86) PCT No.: PCT/EP06/61713

§ 371 Date: Oct. 5, 2007

(30) Foreign Application Priority Data
Apr. 21, 2005 (DE) 102005018700.5

(51) Int. Cl. C08G 69/08; C08G 73/06

(52) U.S. Cl. 528/310; 528/422

(57) ABSTRACT

Use of amphoteric polymers for the treatment of hard surfaces for improving their wettability with polar organic solvents or liquid formulations comprising these solvents.

The present invention relates to the use of amphoteric polymers for the treatment of hard surfaces for improving their wettability with polar organic solvents or liquid formulations comprising these solvents.

Good wettability of surfaces with polar organic solvents or liquid formulations which comprise organic solvents as essential functional constituent is desirable in many areas.

An important example which may be mentioned is the deicing of means of transport, e.g. of aircraft wings and sight glass in cars and trains, but also of cooling elements in heat pumps. Particularly in the case of aircraft, complete deicing is essential since otherwise the aerodynamics are significantly disturbed, which in turn leads to lift decrements, and further safety functions of the aircraft are adversely affected. The deicers usually used are formulations which comprise, as additive which lowers the freezing point, polyhydric alcohols (preferably ethylene glycol, 1,2- or 1,3-propylene glycol, diethylene glycol, dipropylene glycol and/or glycerol) together with water and further possible auxiliaries, such as surfactants, emulsifiers and pH regulators. In order to improve the adhesion of the deicer on the surface to be treated and to prevent the deicer from running off oblique or perpendicular surfaces, thickeners are generally added (e.g. WO-A-98/10032, U.S. Pat. No. 5,708,068). However, this increases the viscosity of the deicer so much that inadequate film formation and thus also inadequate covering of the surface results.

The object of the invention was therefore to enable better wettability of surfaces with polar organic solvents and thus the formation of stable solvent films on the surfaces.

Accordingly, the use of amphoteric polymers for the treatment of hard surfaces for improving their wettability with polar organic solvents or liquid formulations comprising these solvents has been found.

Suitable amphoteric polymers are, in particular, polymers which comprise protonatable or quaternized nitrogen atoms and anionic groups.

Such nitrogen atoms can, for example, be present in the form of primary, secondary or tertiary amino groups, i.e. substituted with one, two or three alkyl and/or aryl radicals and, correspondingly, two, one or no hydrogen atom, or be present in quaternized form. In the quaternary ammonium groups, the nitrogen atoms can have one to four alkyl and/or aryl radicals and, correspondingly, three to no hydrogen atom as substituents.

Suitable anionic groups are, in particular, carboxylate groups, but also further anionic groups which are in equilibrium with the corresponding protonated, uncharged group, e.g. sulfonate, phosphonate and nitrate groups.

Examples of suitable amphoteric polymers are the reaction products of ammonium salts comprising monoethylenically unsaturated radicals, such as diallyldialkyl-ammonium chlorides, trialkylammonium alkyl acrylates, acrylamides, polyalkylenepolyamines, polyamidoamines and polyether amines with monoethylenically unsaturated carboxylic acids, in particular acrylic acid, which are usually prepared by free-radical copolymerization or, in the case of the polymeric amines, by polymer-analogous reaction. The reaction product can additionally comprise building blocks corresponding to nonionic comonomers.

Of particular suitability are polymers based on anionically modified polyamines.

One group of very particularly suitable polymers are water-soluble or water-dispersible polymers which are obtainable by reacting
(a) compounds comprising nitrogen atoms, chosen from the group of polyalkylenepolyamines, polyamidoamines, polyamidoamines grafted with ethyleneimine and polyether amines,
(b) if desired at least bifunctional crosslinkers
(c) compounds comprising free or derivatized acid groups, chosen from the group of α,β-unsaturated carboxylic acids, their salts and their hydrolyzable derivatives, halocarboxylic acids, their salts and their hydrolyzable derivatives, glycidic acid, its salts and its hydrolyzable derivatives, α,β-unsaturated sulfonic acids, α,β-unsaturated phosphonic acids and carboxyalkylating agents based on aldehydes and alkali metal cyanides,
   and hydrolysis of acid groups present in derivatized form to give acid groups which are free or present in salt form.

Such polymers based on carboxylic acid derivatives (c) are known from WO-A-05/073357, which was unpublished at the priority date of the invention, and are used therein for the treatment of hard surfaces for rapid and streak-free drying, to make soil release easier, to reduce or avoid the condensation of water and/or the formation of dried-on traces of water on the surfaces.

Polymers carboxymethylated by reaction with formaldehyde and alkali metal cyanides are disclosed in WO-A-04/01099 and are used therein for the passivation, etching and sealing of metal surfaces and during metal deposition on metal and plastic surfaces. DE-A-10 2004 044 605, which was unpublished at the priority date of the invention, describes their use for the treatment of hard surfaces for improving the run-off behavior of water from the surfaces and for reducing soil and salt deposition on the surfaces.

The polymers preferred according to the invention are to be obtained by reacting the components (a), if desired (b) and (c). They can thus be in crosslinked or uncrosslinked form, where the component (a) has in every case been modified with the component (c).

In this connection, the components (a), if desired (b) and (c) can be used in any ratios relative to one another. If the component (b) is used, the components (a) and (b) are preferably used in a molar ratio of from 100:1 to 1:1000, particularly preferably from 20:1 to 1:20. The molar ratio of the components (a) and (c) is preferably chosen so that the molar ratio of the hydrogen atoms on the nitrogen in (a) to the component (c) is 1:0.2 to 1:0.95, preferably 1:0.3 to 1:0.9, particularly preferably 1:0.4 to 1:0.85.

The polymers are very particularly preferably incipiently crosslinked polymers, i.e. up to 2%, preferably up to 1.5%, particularly preferably up to 1%, of the active N—H bonds present in the component (a) have been reacted with a crosslinker (b).

As component (a) comprising nitrogen atoms, polyalkylenepolyamines, poly-amidoamines, polyamidoamines grafted with ethyleneimine or polyether amines or mixtures of these compounds are used.

The term polyalkylenepolyamines is to be understood here as meaning compounds which comprise at least 3 nitrogen atoms, such as diethylenetriamine, triethylenetetramine, tetraethylenepentamine, pentaethylenehexamine, diaminopropyleneethylenediamine, trisaminopropylamine and polyethyleneimines. The polyethyleneimines have preferably an average molecular weight M_{w} of at least 300, preferably from 800 to 2 000 000, particularly preferably from 20 000 to 1 000 000, very particularly preferably from 20 000 to 750 000 (determined by means of light scattering).

The polyalkylenepolyamines can be partially amidated. Products of this type are prepared, for example, by reacting polyalkylenepolyamines with carboxylic acids, carboxylic acid esters, carboxylic acid anhydrides or carboxylic acid halides. Amidated polyalkylenepolyamines are amidated for the subsequent reactions preferably to 1 to 30%, particularly preferably up to 20%, in each case based on the amidatable nitrogen atoms in the polyalkylenepolyamine. They must also have free NH groups so that they can be reacted with the compounds (b) and (c). Suitable carboxylic acids for the amidation of the polyalkylenepolyamines are saturated and unsaturated aliphatic or aromatic carboxylic acids having generally 1 to 28 carbon atoms, e.g. formic acid, acetic acid, propionic acid, benzoic acid, lauric acid, palmitic acid, stearic acid, oleic acid, linoleic acid and behenic acid. An amidation is of course also possible by reacting polyalkylenepolyamines with alkyl diketenes.

Furthermore, the polyalkyleneamines can be used in partially alkylated form as component (a). Alkylating agents which are particularly suitable are alkyl halides, e.g. methyl chloride, ethyl chloride, butyl chloride, epichlorohydrin and hexyl chloride, dialkyl sulfates, e.g. dimethyl sulfate and diethyl sulfate, and benzyl chloride. If alkylated polyalkylenepolyamines are used as component (a), their degree of alkylation is preferably 1 to 30%, particularly preferably up to 20%.

Further suitable modified polyalkyleneamines are the reaction products of polyethyleneimines with C₂-C₂₂-epoxides. These reaction products are usually prepared by alkoxylation of polyethyleneimines in the presence of bases as catalyst.

The polyamidoamines likewise suitable as components (a) are obtainable, for example, by reacting C₄-C₁₀-dicarboxylic acids with polyalkylenepolyamines which preferably comprise 3 to 10 basic nitrogen atoms in the molecule. Suitable dicarboxylic acids are, for example, succinic acid, maleic acid, adipic acid, glutaric acid, suberic acid, sebacic acid or terephthalic acid. It is also possible to use mixtures of carboxylic acids, e.g. mixtures of adipic acid with glutaric acid or adipic acid. Preference is given to using adipic acid for the preparation of the polyamidoamines. Suitable polyalkylene-polyamines which are condensed with the dicarboxylic acids have already been specified above, e.g. diethylenetriamine, triethylenetetramine, dipropylenetriamine, tripropylenetetramine, dihexamethylenetriamine, aminopropylethylenediamine and bis(aminopropyl)ethylenediamine are suitable. The polyalkylenepolyamines can also be used in the form of mixtures for the preparation of the polyamidoamines. The preparation of the polyamidoamines is preferably carried out without a diluent, but can also, if appropriate, be carried out in inert solvents. The condensation of the dicarboxylic acids with the polyalkylenepolyamines takes place at elevated temperatures, for example in the range from 120 to 220° C. The water formed during the reaction is distilled off from the reaction mixture. The condensation can, if appropriate, be carried out in the presence of lactones or lactams of carboxylic acids having 4 to 8 carbon atoms. Per mole of dicarboxylic acid, generally 0.8 to 1.4 mol of a polyalkylenepolyamine are used. The polyamidoamines obtainable in this way have primary and secondary NH groups and are soluble in water.

The polyamidoamines grafted with ethyleneimine and likewise suitable as component (a) can be prepared by allowing ethyleneimine to act in the presence of Brönstedt or Lewis acids, e.g. sulfuric acid, phosphoric acid or boron trifluoride etherate, on the polyamidoamines described above. Under the specified conditions, ethyleneimine is grafted onto the polyamidoamine. For example, per basic nitrogen group in the polyamidoamine, 1 to 10 ethyleneimine units can be grafted on.

The polyether amines which can further be used as component (a) are known, for example, from DE-A-29 16 356. The polyether amines can be obtained by condensation of di- and polyamines with chlorohydrin ethers at elevated temperatures. The amines can comprise up to 10 nitrogen atoms. The chlorohydrin ethers are prepared, for example, by reacting dihydric C₂-C₅-alcohols, the alkoxylation products of these alcohols having up to 60 alkylene oxide units, glycerol or polyglycerol which comprises up to 15 glycerol units, erythritol or pentaerythritol with epichlorohydrin. Per mole of the specified alcohols, at least 2 to 8 mol of epichlorohydrin are used. The reaction of the di- and polyamines with the chlorohydrin ethers is usually carried out at temperatures of from 110 to 200° C. Furthermore, the polyether polyamines can be prepared by condensation of diethanolamine or triethanolamine by known processes, as are disclosed, for example, in U.S. Pat. Nos. 4,404,362, 4,459,220 and 2,407,895.

Preferred components (a) are polyalkylenepolyamines. Particular preference is given to polyalkylenepolyamines, in particular polyethyleneimines, having an average molecular weight M_{w} of from 800 to 2 000 000, especially from 20 000 to 1 000 000 and in particular from 20 000 to 750 000.

Suitable as component (b) are at least bifunctional crosslinkers which have, as functional groups, a halohydrin, glycidyl, aziridine or isocyanate unit or a halogen atom.

Suitable crosslinkers are, for example, epihalohydrins, preferably epichlorohydrins, and α,ω-bis(chlorohydrin)polyalkylene glycol ether and the α,ω-bisepoxides of polyalkylene glycol ethers obtainable therefrom by treatment with bases. The chlorohydrin ethers can be prepared, for example, by reacting polyalkylene glycols and epichlorohydrin in the molar ratio 1:2 to 1:5. Suitable polyalkylene glycols are, for example, polyethylene glycols, polypropylene glycols and polybutylene glycols, and block copolymers of C₂-C₄-alkylene oxides. The average molecular weight M_{w} of the polyalkylene glycols are generally 100 to 6000, preferably 300 to 2000. α,ω-Bis(chlorohydrin)polyalkylene glycol ethers are described, for example, in U.S. Pat. No. 4,144,123. It also describes that the bisglycidyl ethers can be obtained by reacting the corresponding dichlorohydrin ethers with bases.

Further suitable crosslinkers are α,ω-dichloropolyalkylene glycols, as are disclosed, for example, in EP-A-025 515. These α,ω-dichloropolyalkylene glycols are obtainable by either reacting di- to tetrahydric alcohols, preferably alkoxylated di- to tetrahydric alcohols, with thionyl chloride with the elimination of HCl and subsequent catalytic decomposition of the chlorosulfonated compounds with the elimination of sulfur dioxide, or converting them using phosgene with the elimination of HCl to the corresponding bischlorocarboxylic acid acid esters and then decomposing these catalytically with the elimination of carbon dioxide.

The di- to tetrahydric alcohols are preferably ethoxylated and/or propoxylated glycols which are reacted with 1 to 100, in particular 4 to 40, mol of ethylene oxide per mole of glycol.

Further suitable crosslinkers are α,ω- or vicinal dichloroalkanes, e.g. 1,2-dichloro-ethane, 1,2-dichloropropane, 1,3-dichloropropane, 1,4-dichlorobutane and 1,6-dichlorohexane.

Further suitable crosslinkers are the reaction products of these trihydric alcohols with epichlorohydrin to give reaction products which have at least two chlorohydrin units. For example, the polyhydric alcohols used are glycerol, ethoxylated or propoxylated glycerols, polyglycerol having 2 to 15 glycerol units in the molecule, and, if appropriate, ethoxylated and/or propoxylated polyglycerols. Crosslinkers of this type are known, for example, from DE-A-29 16 356.

Furthermore, suitable crosslinkers are those which comprise blocked isocyanate groups, e.g. trimethylhexamethylene diisocyanate blocked with 2,2,3,6-tetramethyl-piperidinone-4. These crosslinkers are known, for example, from DE-A-40 28 285.

Furthermore, crosslinkers comprising aziridine units and based on polyethers or substituted hydrocarbons, e.g. 1,6-bis(N-aziridino)hexane are suitable.

It is of course also possible to use mixtures of two or more crosslinkers.

Preferred components (b) are epihalohydrins, in particular epichlorohydrin, α,ω-bis(chlorohydrin)polyalkylene glycol ether, α,ω-bis(epoxides) of polyalkylene glycol ethers and bisglycidyl ethers of polyalkylene glycols.

As component (c), compounds which comprise free or derivatized acid groups and are chosen from the group of α,β-unsaturated carboxylic acids, their salts and their hydrolyzable derivatives, halocarboxylic acids, their salts and their hydrolyzable derivatives, glycidic acid, its salts and its hydrolyzable derivatives, α,β-unsaturated sulfonic acids, α,β-unsaturated phosphonic acids and carboxyalkylating agents based on aldehydes and alkali metal cyanides are used.

Suitable acid derivatives here are, in particular, the esters, amides and nitriles, which are converted to the free carboxylic acids or their salts through hydrolysis which follows the reaction with (a) (and if desired (b)).

As in the case of components (a) and (b), it is of course also possible to use mixtures of different components (c).

α,β-Unsaturated carboxylic acids suitable as component (c) have preferably 3 to 18 carbon atoms in the alkenyl radical. These are preferably α,β-unsaturated monocarboxylic acids and unsaturated dicarboyxlic acids which have a double bond in the α position relative to at least one carboxyl group. Examples of particularly suitable carboxylic acids are acrylic acid, methacrylic acid, dimethacrylic acid, ethylacrylic acid, maleic acid, fumaric acid, methylenemalonic acid, citraconic acid and itaconic acid. Preference here is given to acrylic acid, methacrylic acid and maleic acid.

It is of course also possible to use anhydrides of these acids, e.g. maleic anhydride.

Salts of the carboxylic acids suitable as component (c) are, in particular, the alkali metal, alkaline earth metal and ammonium salts. Preference is given to the sodium, potassium and ammonium salts. The ammonium salts can be derived either from ammonia or from amines or amine derivatives such as ethanolamine, diethanolamine and triethanolamine. Suitable alkaline earth metal salts are primarily the magnesium and calcium salts.

Esters of the unsaturated carboxylic acids suitable as component (c) are derived in particular from monohydric C₁-C₂₀-alcohols or dihydric C₂-C₆-alcohols. Examples of particularly suitable esters are methyl (meth)acrylate, ethyl (meth)acrylate, n-propyl (meth)acrylate, isopropyl (meth)acrylate, n-butyl (meth)acrylate, isobutyl (meth)acrylate, 2-ethylhexyl acrylate, 2-ethylhexyl methacrylate, palmityl (meth)acrylate, lauryl (meth)acrylate, stearyl (meth)acrylate, dimethyl maleate, diethyl maleate, isopropyl maleate, 2-hydroxyethyl (meth)acrylate, 2- and 3-hydroxypropyl (meth)acrylate, hydroxybutyl (meth)acrylate and hydroxyhexyl (meth)acrylate.

The amides of the unsaturated carboxylic acids that are likewise suitable as component (c) are, in particular, the unsubstituted amides, e.g. (meth)acrylamide, although it is also possible to use substituted amides which carry one or two substituents, such as C₁-C₆-alkyl, on the amide nitrogen atom.

A particular group of the substituted amides (c) are the reaction products of α,β-unsaturated monocarboxylic acids, in particular of (meth)acrylic acid, with amidoalkanesulfonic acids. Of particular suitability here are amides of the formulae I or II:

H₂C═CH—X—SO₃H I

H₂C═C(CH₃)—X—SO₃H II

in which X is one of the spacer groups —C(O)—NH—[CH₂₋ₙ(CH₃)ₙ]—(CH₂)ₘ—, —C(O)NH— or —C(O)—NH—[CH(CH₂CH₃)]—, where n is 0 to 2 and m is 0 to 3.

Particular preference is given to 1-acrylamido-1-propanesulfonic acid (formula I: X═—C(O)—NH—[CH(CH₂CH₃)]—), 2-acrylamido-1-propanesulfonic acid (formula I: X═—C(O)—NH—[CH(CH₃)]—CH₂—), 2-acrylamido-2-methyl-1-propanesulfonic acid (formula I: X═—C(O)—NH—[C(CH₃)₂]—CH₂—) and 2-methacrylamido-2-methyl-1-propanesulfonic acid (formula II: X═—C(O)—NH—[C(CH₃)₂]—CH₂—).

Finally, nitrites of the unsaturated carboxylic acids suitable as component (c) are, in particular, acrylonitrile and methacrylonitrile.

Further suitable as component (c) are halocarboxylic acids, in particular chlorocarboxylic acids which comprise preferably 2 to 5 carbon atoms and up to 2 chlorine atoms. Particularly suitable examples are chloroacetic acid, 2- and 3-chloropropionic acid, 2- and 4-chlorobutyric acid, dichloroacetic acid and 2,2′-dichloropropionic acid.

Instead of the halocarboxylic acids themselves and their salts, it is of course also possible to use their hydrolyzable derivatives, in particular their esters, amides and nitrites.

Also suitable as component (c) are glycidic acid and its salts, especially its alkali metal, alkaline earth metal and ammonium salts, e.g. its sodium, potassium, magnesium, calcium and ammonium salt.

The glycidic acid can of course also be used in derivatized form, in particular as amide or ester, especially C₁-C₄-alkyl or C₂-C₄-hydroxyalkyl esters, e.g. methyl glycidate, ethyl glycidate, n-propyl glycidate, n-butyl glycidate, isobutyl glycidate, 2-ethylhexyl glycidate, 2-hydroxypropyl glycidate and 4-hydroxybutyl glycidate.

Preference is given to glycidic acid, its sodium, potassium and ammonium salts, and glycidamide.

Likewise suitable as component (c) are α,β-unsaturated sulfonic acids, such as vinylsulfonic acid.

Finally, α,β-unsaturated phosphonic acids, such as vinylphosphonic acid, are also suitable as component (c).

Further suitable as component (c) are also carboxyalkylating agents based on aldehydes and alkali metal cyanides. These may be mixtures of these compounds themselves or be cyanohydrins as reaction products thereof, e.g. glycol nitrite.

Suitable aldehydes here are, for example, aliphatic aldehydes, in particular alkanals having 1 to 10 carbon atoms, such as acetaldehyde and especially formaldehyde, and aromatic aldehydes, such as benzaldehyde.

Suitable alkali metal cyanides are, in particular, potassium cyanide and especially sodium cyanide.

As component (c), preference is given to monoethylenically unsaturated carboxylic acids, in particular acrylic acid, methacrylic acid and maleic acid, where acrylic acid is particularly preferred.

The polymers based on the abovementioned components (c) can be prepared by generally known processes. Suitable preparation processes for polymers which are based on carboxylic acids, chlorocarboxylic acids and glycidic acid, and derivatives thereof (c) are described, for example, in DE-A-42 44 194, according to which either the component (a) is firstly reacted with the component (c) and only then is the component (b) added, or the components (c) and (b) are reacted at the same time with the component (a).

However, the polymers according to the invention are preferably prepared by incipiently crosslinking the component (a) firstly with the component (b) (step i)) and then reacting it with the component (c) (step ii)).

The crosslinking (step i)) can be carried out by known processes. Usually, the crosslinker (b) is used as aqueous solution, meaning that the reaction takes place in aqueous solution. The reaction temperature is generally 10 to 200° C., preferably 30 to 100° C. The reaction is usually carried out at atmospheric pressure. The reaction times depend on the components (a) and (b) used and are generally 0.5 to 20 h, in particular 1 to 10 h. The product obtained can be isolated or, preferably, be reacted directly in step ii) in the form of the solution produced.

In step ii), the reaction of the product obtained in step i) takes place with those compounds of group (c) which comprise a monoethylenically unsaturated double bond, in the manner of a Michael addition, while halocarboxylic acids and glycidic acid or the derivatives of these acids react via the halogen atom or the epoxide group with the primary or secondary amino groups of the incipiently crosslinked product obtained in step i). The reaction is usually carried out in aqueous solution at 10 to 200° C., preferably at 30 to 100° C., and under atmospheric pressure. The reaction time is dependent on the components used and is generally 5 to 100 h, especially 1 to 50 h.

If the abovementioned acid components (c) have been used in derivatized form, then the derivatized acid groups are converted to the free acid groups or their salts in an additional hydrolysis step (iii).

The carboxyalkylation with aldehydes and alkali metal cyanides in step ii) can be carried out continuously, batchwise or semicontinuously in accordance with methods which are known and described, for example, in WO-A-97/40087 for the carboxymethylation.

In processing terms, the procedure preferably involves adding aldehyde and alkali metal cyanide to an aqueous solution of the incipiently crosslinked polymer comprising amino groups at the same time over 0.5 to 10 h, a slight excess of alkali metal cyanide in the reaction mixture being preferred. Preferably, therefore, a small amount of alkali metal cyanide is initially introduced in the polymer solution, e.g. 2 to 10 mol %, based on the active N—H bonds, and aldehyde and alkali metal cyanide are added in the molar ratio of about 1:1 either separately from one another or in the form of a mixture.

For complete carboxyalkylation, 1 mol of aldehyde and 1 mol of alkali metal cyanide are required per mole of NH group to be carboxyalkylated. Preference is, however, given to a degree of carboxyalkylation of from 20 to 95%, in particular of up to 85%. Accordingly, deficits of aldehyde and alkali metal cyanide are used. Preferred amounts are 0.2 to 0.95 mol, in particular up to 0.85 mol, of aldehyde and 0.2 to 0.95 mol, especially up to 0.85 mol, of alkali metal cyanide per mole of active N—H groups.

The amphoteric polymers increase the wettability of hard surfaces with polar organic solvents or liquid formulations comprising these solvents and stabilize the liquid films formed on the surfaces during wetting.

The polar solvents may be protic solvents, such as alcohols and carboxylic acids, or aprotic solvents, such as carboxamides, carboxylic acid esters, ketones and dimethyl sulfoxide.

From these classes of solvent, specific examples are as follows:
alcohols:
monohydric alcohols, in particular C₁-C₁₀-alkanols, e.g. methanol, ethanol, n-propanol, isopropanol, isobutanol, tert-butanol, 1-hexanol, cyclohexanol and phenol;
polyhydric alcohols, in particular di- and trihydric alcohols, such as C₂-C₄-alkylene glycols and oligomers and polymers thereof, e.g. ethylene glycol, 1,2- and 1,3-propylene glycol, 1,2- and 1,4-butylene glycol, diethylene glycol, dipropylene glycol, polyethylene glycol and glycerol;
carboxylic acids:
saturated aliphatic carboxylic acids, in particular saturated C₁-C₁₀-carboxylic acids, e.g. acetic acid and propionic acid;
unsaturated aliphatic carboxylic acids, in particular unsaturated C₃-C₁₀-carboxylic acids, e.g. acrylic acid;
carboxamides:
amides of saturated aliphatic carboxylic acids, in particular of C₁-C₁₀-carboxylic acids, e.g. formamide and acetamide;
cyclic saturated amides, e.g. pyrrolidone and N—C₁-C₂-alkylpyrrolidones, such as N-methylpyrrolidone;
carboxylic acid esters;
alkyl esters of saturated aliphatic carboxylic acids, in particular C₁-C₆-alkyl esters of saturated C₂-C₆-carboxylic acids, e.g. ethyl acetate;
alkyl esters of unsaturated aliphatic carboxylic acids, in particular C₁-C₁₀-alkyl esters of unsaturated C₃-C₁₀-carboxylic acids, e.g. butyl acrylate;
ketones:
aliphatic ketones, in particular C₃-C₁₀-ketones, e.g. acetone and ethyl methyl ketone;
cycloaliphatic ketones, in particular cyclic C₄-C₁₀-ketones, e.g. cyclohexanone.

The amphoteric polymers have particular importance for increasing the wettability with protic solvents and mixtures of these solvents with water, and formulations which are based on these solvents or mixtures of these solvents with water.

They can be used particularly advantageously for the deicing of means of transport of all types, in particular of aircraft, automobiles and trains, since they increase the wettability of these means of transport, e.g. the aircraft wings and the sight glass, with deicers.

Examples of further fields of use are corrosion protection and the cleaning and pretreatment of surfaces for a coating.

The amphoteric polymers can in principle be used for treating all types of hard surfaces, in particular smooth surfaces. By way of example, mention may be made of painted metal and plastic surfaces, surfaces made of glass, metal, e.g. stainless steel, enamel or plastic and ceramic.

The hard surfaces are treated by bringing the amphoteric polymers into contact with the hard surface, which can be done by flushing, spraying, wiping, immersing or other methods known to the person skilled in the art.

The amphoteric polymers are used here preferably in the form of solutions/dispersions in water, alcohols or water/alcohol mixtures. The polymer content of these solutions/dispersions is generally 0.01 to 10% by weight, in particular 0.1 to 2% by weight.

It is, however, also possible to incorporate them directly into the formulation, e.g. the deicers, which are to be applied to the hard surfaces.

### EXAMPLES

### A) Preparation of Amphoteric Polymers

### Polymer P1

In a four-necked flask fitted with metal stirrer and reflux condenser, 196 g of anhydrous polyethyleneimine (average molecular weight M_{w} 25 000) were initially introduced under a nitrogen atmosphere and diluted to 25% by weight with 588 g of distilled water. After heating to 70° C. with stirring, at this temperature, 40 ml of a 22% strength by weight aqueous solution of a reaction product of polyethylene glycol (average molecular weight M_{w} 1500) with 2 equivalents of epichlorohydrin were added over 5 min. Following after-stirring for five hours at 70° C. and subsequent heating to 80° C., 263.2 g of acrylic acid were added dropwise at this temperature over 3 h. Following after-stirring for 1 hour at 80° C., the reaction mixture was cooled to room temperature.

A viscous, yellow-orange-colored solution of the polymer P1 with a solids content of 42% by weight (2 h, vacuum/120° C.) and a K value of 17 (determined in accordance with Fikentscher in 1% strength by weight aqueous solution at 23° C.) was obtained.

### Polymer P2

In a four-necked flask fitted with metal stirrer and reflux condenser, 350 g of a 56% strength by weight aqueous solution of polyethyleneimine (average molecular weight M_{w} 25 000) were initially introduced under a nitrogen atmosphere and diluted to 24% by weight with 456 g of distilled water. After heating to 80° C. with stirring, 259.4 g of acrylic acid were added dropwise at this temperature over 3 h. Following after-stirring for 6 hours at 80° C., the reaction mixture was cooled to room temperature.

A viscous, yellow-orange-colored solution of the polymer P2 with a solids content of 43.2% by weight (2 h, vacuum/120° C.) and a K value of 14.9 (determined in accordance with Fikentscher in 1% strength by weight aqueous solution at 23° C.) was obtained.

### Polymer P3

In a four-necked flask fitted with metal stirrer and reflux condenser, 350 g of a 56% strength by weight aqueous solution of polyethyleneimine (average molecular weight M_{w} 25 000) were initially introduced under a nitrogen atmosphere and diluted to 24% by weight with 456 g of distilled water. After heating to 70° C. with stirring to 70° C., 18 ml of a 50% strength by weight aqueous solution of a reaction product of polyethylene glycol (average molecular weight M_{w} 660) with 2 equivalents of epichlorohydrin were added at this temperature over 5 min. Following after-stirring for 5 hours at 70° C. and subsequent heating to 80° C., 259.4 g of acrylic acid were added dropwise at this temperature over 3 h. Following after-stirring for one hour at 95° C., the reaction mixture was cooled to room temperature.

A viscous, yellow-orange-colored solution of the polymer P3 with a solids content of 44.1% by weight (2 h, vacuum/120° C.) and a K value of 23.1 (determined in accordance with Fikentscher in 1% strength by weight aqueous solution at 23° C.) was obtained.

### B) Use of Amphoteric Polymers

### Example 1

3 g of 0.5% strength by weight aqueous solution of the polymer in question were applied to a stainless steel plate (10×10 cm) and spread evenly using a Kimtex® Lite cloth (Kimberly-Clark). After drying, the treated plate was sprayed with 5 ml of ethylene glycol.

For comparison, an untreated stainless steel plate was sprayed with the same amount of ethylene glycol.

On the stainless steel plates treated with the polymer P1, P2 or P3, a uniform, gapless film of ethylene glycol formed. In contrast to this, the ethylene glycol on the untreated stainless steel plate spread only irregularly and with many of gaps.

### Example 2

0.3 g of a 0.5% strength by weight aqueous solution of the polymer P1 was applied to a shiny white ceramic tile (10×10 cm; Novoker) and distributed evenly using a Kimtex Lite cloth (Kimberly-Clark). After drying, the wettability of the treated tile with various organic solvents was investigated.

For this, the solvent in question was applied to the tile at 23° C. in the form of a drop and the contact angle which it produced in each case was determined using an instrument called Dataphysics Contact Angle System OCA 15+ using the software SCA 20.2.0 (November 2002).

The contact angle is a measure of the wettability of the surface. The smaller this angle, the better the wettability.

The measurement results obtained are summarized in the table below. For comparison, the measurement results obtained using an untreated ceramic tile are also listed.

TABLE

Contact angle [°]

| Solvent | Treated tile | Untreated tile |
|---|---|---|
| Ethylene glycol | 9.7 ± 0.9 | 12.0 ± 1.0 |
| Formamide | 5.2 ± 0.5 | 9.2 ± 0.8 |

1-9. (canceled)

10. A method for improving the wettability of a hard surface with polar organic solvents or liquid formulations comprising such solvents by bringing into contact with said surface an amphoteric polymer.

11. The method according to claim 10, wherein the polymer comprises protonatable or quaternized nitrogen atoms and anionic groups.

12. The method according to claim 10, wherein the polymer is based on an anionically modified polyamine.

13. The method according to claim 10, wherein the polymer is water-soluble or water-dispersible and is obtained by reacting
(a) a compound chosen from the group consisting of polyalkylene polyamines, polyamidoamines, polyamidoamines grafted with ethyleneimine and polyether amines,
(b) optionally, at least one bifunctional crosslinker
and
(c) a compound comprising free or derivatized acid groups, chosen from the group consisting of α,β-unsaturated carboxylic acids, their salts and their hydrolyzable derivatives, halocarboxylic acids, their salts and their hydrolyzable derivatives, glycidic acid, its salts and its hydrolyzable derivatives, α,β-unsaturated sulfonic acids, α,β-unsaturated phosphonic acids and carboxyalkylating agents based on aldehydes and alkali metal cyanides,
and hydrolyzing the acid groups present in derivatized form to give acid groups which are free or present in salt form.

14. The method according to claim 13, wherein the polymer is one in which component (a) is a polyalkyleneimine.

15. The method according to claim 13, wherein the polymer is one in which component (c) is an α,β-unsaturated carboxylic acid.

16. The method according to claim 13, wherein the polymer is one in which up to 2% of the active N—H bonds present in component (a) have been reacted with a crosslinker (b).

17. A method of improving the wettability of a hard surface with a liquid formulation based on protic organic solvents by bringing into contact with said surface an amphoteric polymer.

18. A method of improving the wettability of a deicer formulation to a hard surface by incorporating an amphoteric polymer directly into said formulation.
